(19) United States
(12) Patent Application Publication
(10) Pub. No.: US 2014/0304459 A1
(43) Pub. Date: Oct. 9, 2014

(54) MULTI LEVEL CELL MEMORY SYSTEM

(71) Applicant: Samsung Electronics Co., Ltd., Suwon-Si (KR)

(72) Inventors: Moo-Sung KIM, Yongin-si (KR); Byung-Hei JUN, Seoul (KR)

(73) Assignee: Samsung Electronics Co., Ltd., Suwon-Si (KR)

(21) Appl. No.: 14/210,883

(22) Filed: Mar. 14, 2014

(30) Foreign Application Priority Data
Apr. 5, 2013 (KR) 10-2013-0037561

(51) Int. Cl. G06F 12/02

(52) U.S. Cl. CPC G06F 12/0246
USPC 711/103

(57) ABSTRACT

A multi level cell memory system may include a nonvolatile memory device including a memory cell array configured to store first bit page data and second bit page data, and a page buffer configured to store data to be programmed in the memory cell array; and a memory controller configured to input first bit page data and second bit page data into the page buffer, wherein the memory controller is configured such that the memory controller inputs the first bit page data into the page buffer to temporarily store the first bit page data in a first bit page program operation, and inputs the second bit page data into the page buffer together with the temporarily stored first bit page data in a second bit page program operation.

### CROSS-REFERENCE TO RELATED APPLICATION

This application claims priority from Korean Patent Application No. 10-2013-0037561 filed on Apr. 5, 2013 in the Korean Intellectual Property Office, and all the benefits accruing therefrom under 35 U.S.C. 119, the entire contents of which are incorporated herein by reference.

### BACKGROUND

1. Field

At least some example embodiments of the inventive concepts relate to a multi level cell memory system.

2. Description of the Related Art

A memory device may be largely divided into a single level cell (SLC) memory device storing 1-bit data into one memory cell and a multi level cell (MLC) memory device storing N-bit data into one memory cell, where N is a natural number greater than or equal to 2. In a case of an MLC memory device storing 2-bit data into one memory cell, the lower data bit is defined as a least significant bit (LSB) and the upper data bit is defined as a most significant bit (MSB).

### SUMMARY

At least some example embodiments of the inventive concepts provide a multi level cell memory system, which can solve a target program state determination error in an MSB page program operation.

The above and other objects of at least some example embodiments of the inventive concepts will be described in or be apparent from the following description of the preferred embodiments.

According to at least one example embodiment of the inventive concepts, a multi level cell memory system includes a nonvolatile memory device including a memory cell array configured to store first bit page data and second bit page data, and a page buffer configured to store data to be programmed in the memory cell array; and a memory controller configured to input first bit page data and second bit page data into the page buffer, wherein the memory controller is configured such that the memory controller inputs the first bit page data into the page buffer to temporarily store the first bit page data in a first bit page program operation, and inputs the second bit page data into the page buffer together with the temporarily stored first bit page data in a second bit page program operation.

According to at least one example embodiment of the inventive concepts, a nonvolatile memory device configured to store data; and a memory controller configured to input data to be programmed to the nonvolatile memory device, wherein the nonvolatile memory device includes, a memory cell array, a first latch configured to temporarily store first bit page data to be programmed in the memory cell array, and a second latch configured to temporarily store second bit page data to be programmed in the memory cell array, the memory controller being configured such that the memory controller, dumps the first bit page data to the first latch in the first bit page program operation and the second bit page program operation, and dumps the second bit page data to the second latch in the second bit page program operation.

According to at least one example embodiment, a memory system includes a nonvolatile memory device, the nonvolatile memory device including, an array of multi-level memory cells, and a page buffer; and a memory controller, the memory controller being configured to program first bits into selected cells, from among the array of multi-level memory cells, by storing first page data corresponding to the first bits in the page buffer, and programming the first bits into the selected memory cells based on the first page data stored in the page buffer, and program second bits into the selected cells by storing second page data corresponding to the second bits in the page buffer, and programming the second bits into the selected memory cells based on both the first page data and the second page data stored in the page buffer.

### BRIEF DESCRIPTION OF THE DRAWINGS

The above and other features and advantages of example embodiments will become more apparent by describing in detail example embodiments with reference to the attached drawings. The accompanying drawings are intended to depict example embodiments and should not be interpreted to limit the intended scope of the claims. The accompanying drawings are not to be considered as drawn to scale unless explicitly noted.

FIG. 1 is a block diagram of a memory system according to at least some example embodiments of the inventive concepts;

FIG. 2 is a detailed block diagram of the memory system shown in FIG. 1;

FIG. 3 is a detailed block diagram of a nonvolatile memory device shown in FIG. 1;

FIG. 4 is a detailed circuit diagram of a memory block of a memory cell array shown in FIG. 3;

FIG. 5 illustrates a program state of the memory cell array shown in FIG. 3;

FIG. 6 illustrates a program process of the memory cell array shown in FIG. 3;

FIG. 7 illustrates an LSB page read error in an MSB page program operation;

FIG. 8 is a flowchart illustrating a program operation of the memory system shown in FIG. 1;

FIG. 9 is a flowchart illustrating an application example of the program operation of the memory system shown in FIG. 1;

FIG. 10 is a block diagram illustrating an application example of the program operation of the memory system shown in FIG. 1;

FIG. 11 is a block diagram illustrating a user system including a solid state drive;

FIG. 12 is a block diagram of a user system including a memory card; and

FIG. 13 is a block diagram of a computing system including the memory system shown in FIG. 1 or 10.

### DETAILED DESCRIPTION OF THE EMBODIMENTS

Detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Example embodiment of the inventive concepts will be described with reference to perspective views, cross-sectional views, and/or plan views, in which at least some example embodiments of the inventive concepts are shown. Thus, the profile of an exemplary view may be modified according to manufacturing techniques and/or allowances. That is, the example embodiments of the inventive concepts are not intended to limit the scope of the inventive concepts but cover all changes and modifications that can be caused due to a change in manufacturing process. Thus, regions shown in the drawings are illustrated in schematic form and the shapes of the regions are presented simply by way of illustration and not as a limitation.

Hereinafter, example embodiments of the inventive concepts will be described with reference to the accompanying drawings.

At least some example embodiments of the inventive concepts will be described with regard to a NAND flash memory device. However, it is obvious to one skilled in the art that the inventive concepts can be applied to other types of nonvolatile memory devices.

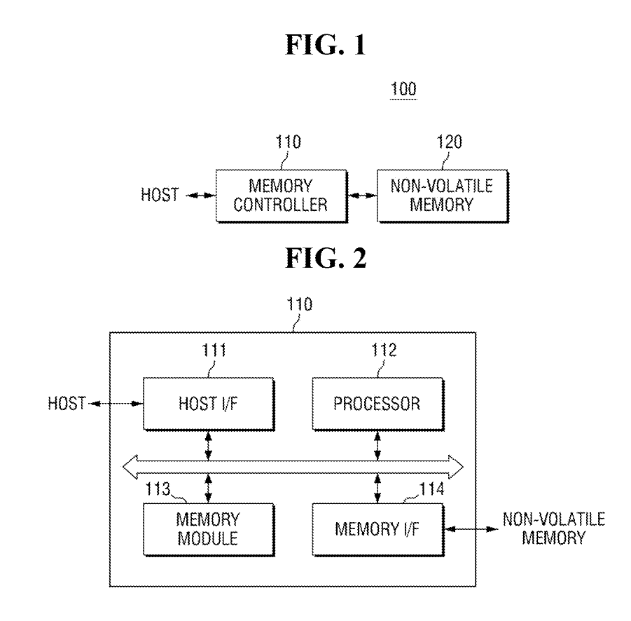

FIG. 1 is a block diagram of a memory system according to at least one example embodiment of the inventive concepts.

Referring to FIG. 1, the memory system 100 may include a memory controller 110 and a nonvolatile memory device 120.

The memory controller 110 may be configured to access the nonvolatile memory device 120 in response to a request from the host. For example, the memory controller 110 may be configured to control read, write, erase, and background operations of the nonvolatile memory device 120. The memory controller 110 may be configured to drive firmware for controlling the nonvolatile memory device 120.

The nonvolatile memory device 120, including a memory cell (MC) array, may be configured to store data. For example, the nonvolatile memory device 120 may be provided as a NAND flash memory device.

FIG. 2 is a detailed block diagram of the memory system shown in FIG. 1.

Referring to FIG. 2, memory controller 110 may include host interface (I/F) 111, processor 112, memory module 113, memory interface (I/F) 114.

The host interface 111 may include an interface protocol for exchanging data/commands with the host. As an example, the host interface 111 may be configured to communicate with an external device (host) through one of various standardized interface protocols such as Universal Serial Bus (USB), Multimedia Card (MMC), Peripheral Component Interconnection (PCI), PCI-Express (PCI-E), Advanced Technology Attachment (ATA, Parallel-ATA, pATA), Serial-ATA (SATA), Small Computer Small Interface (SCSI), Enhanced Small Disk Interface (ESDI), and Integrated Drive Electronics (IDE).

The processor 112 may be configured to control the overall operation of the memory controller 110.

The memory module 113 may be used as at least one of a working memory of the processor 112, a cache memory between the nonvolatile memory device 120 and the host, and a buffer memory between the nonvolatile memory device 120 and the host. The memory module 113 may receive data to be written in the nonvolatile memory device 120 from the processor 112 and may temporarily store the received data. The data temporarily stored in the memory module 113 may be transmitted to the nonvolatile memory device 120 in the next stage to then be programmed. For example, the memory module 113 may include a static random access memory (SRAM), but not limited thereto.

The memory interface 114 may interface with the nonvolatile memory device 120. Here, the memory interface 114 may include, for example, a NAND interface.

Although not shown in FIG. 2, the memory controller 110 may further include an error correction block. The error correction block may be configured to detect and correct an error of the data stored in the memory controller 110 using an error correction code (ECC).

As an example, the error correction block may be provided as a component of the memory controller 110. Alternatively, the error correction block may also be provided as a component of the nonvolatile memory device 120.

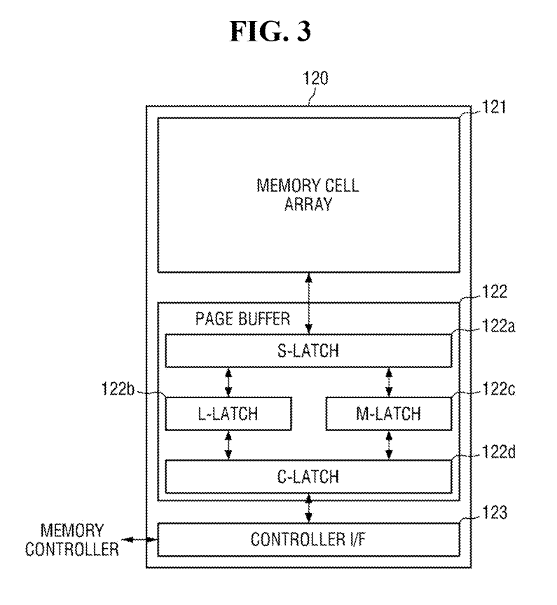

FIG. 3 is a detailed block diagram of a nonvolatile memory device shown in FIG. 1.

Referring to FIG. 3, the nonvolatile memory device 120 includes a memory cell array 121, a page buffer 122, and a controller I/F 123.

The memory cell array 121 may include a plurality of memory cells having a plurality of rows and a plurality of columns arrayed. The plurality of memory cells may constitute a plurality of memory blocks. The respective memory cells may be configured to store N-bit data, where N is a natural number of 2 or greater. That is to say, the memory cell array 121 may include a multi level cell (MLC) storing N-bit data. The memory cell array 121 may be divided into a data region for storing ordinary data and a spare region for storing side information associated with the ordinary data (e.g., flag information, an error correction code, a device code, a maker code, page information, etc.).

For the sake of convenient explanation, the following description of an MLC memory device will be made with regard to an MLC memory device having a memory cell storing 2-bit data by way of example.

The memory cell array 121 stores 2-bit (or more bits) in one memory cell, and a lower bit is referred to as a least significant bit (LSB) and an upper bit is referred to as a most significant bit (MSB). The LSB and the MSB are programmed in the same memory cell connected to the same word line. Here, in a case of programming or reading the lower bit, the lower-bit data becomes an LSB page, and in a case of programming or reading the upper bit, the upper-bit data becomes an MSB page. Since the 2-bit data constitutes two different pages, the LSB page and the MSB page are programmed by different page addresses.

The program or read operation of the memory cell array 121 may be performed in units of pages, and the erase operation of the programmed data may be performed in units of blocks including a plurality of pages. Page addresses may be consecutively or non-consecutively allocated in a word line direction during a program operation. The information associated with the program operation or the erase operation for each page may be stored in memory cells allocated to the spare region (or some portions of the data region).

The page buffer 122 may operate as a write driver or a sense amplifier according to the operation of the nonvolatile memory device 120. For example, the page buffer 122 may operate as a write driver when the nonvolatile memory device 120 performs a program operation and may operate as a sense amplifier when the nonvolatile memory device 120 performs a read operation.

The page buffer 122 may include data latches connected to bit lines. The page buffer 122 may receive data to be programmed from the memory controller 110. The data latches may temporarily store the data to be programmed to memory cells connected to selected word lines or data read from the memory cells. For example, the data latches may include an S-latch 122a, an L-latch 122b, an M-latch 122c, and a C-latch 122d. The C-latch 122d is connected to the memory controller 110 and may exchange data with respect to the memory controller 110. The L-latch 122b may temporarily store LSB page data to be programmed, and the M-latch 122c may temporarily store MSB page data to be programmed. The S-latch 122a may set a target program state using the data temporarily stored in the L-latch 122b and the data temporarily stored in the M-latch 122c. The L-latch 122b and the M-latch 122c may transmit the data between the S-latch 122a and the C-latch 122d.

As will later be described, the page buffer 122 may perform an initial read operation. The page buffer 122 may read the LSB page data from the memory cells connected to selected word lines in an MSB page program operation and may store the read LSB page data. The read LSB page data may be sent up to the L-latch 122b through the S-latch 122a.

The controller interface 123 may be configured to interface with the memory controller 110. The controller interface 123 may include, for example, a NAND interface.

Although not shown in FIG. 3, the nonvolatile memory device 120 may further include additional control circuits for controlling the operations of the page buffer 122 and the controller interface 123.

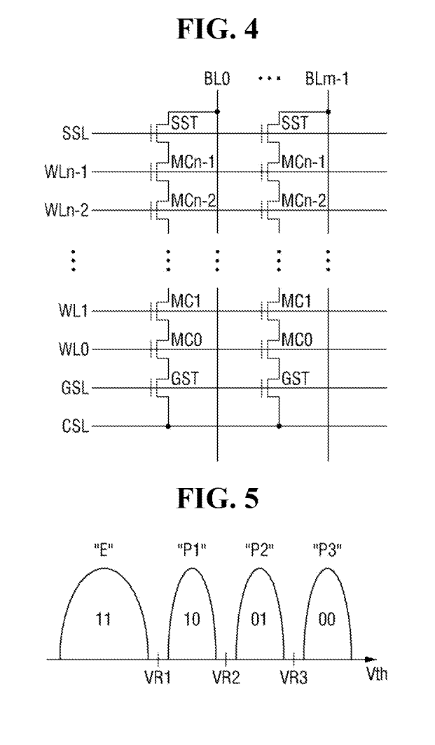

FIG. 4 is a detailed circuit diagram of a memory block of a memory cell array shown in FIG. 3.

Referring to FIG. 4, memory cells constituting a memory block may have an NAND string structure. The NAND string structure shown in FIG. 4 may be applied to not only memory cells in a data region but also memory cells in a spare region.

The memory block may include a plurality of strings corresponding to a plurality of columns or bit lines BL0 to BLm−1. Each of the plurality of strings may include a string select transistor SST, a plurality of memory cells MC0 to MCn−1, and a ground select transistor GST. In each string, a drain of the string select transistor SST may be connected to a corresponding bit line, and a source of the ground select transistor GST may be connected to a common source line CSL. The plurality of memory cells MC0 to MCn−1 may be connected in series between the source of the string select transistor SST and the drain of ground select transistor GST. Gates of the memory cells arranged on the same row may be commonly connected to corresponding word lines WL0 to WLn−1. The string select transistor SST may be controlled by a voltage applied through a string select line SSL, and the ground select transistor GST may be controlled by a voltage applied through a ground select line GSL. The memory cells MC0 to MCn−1 may be controlled by voltages applied through the corresponding word lines WL0 to WLn−1. The memory cells connected to the word lines WL0 to WLn−1 may store data corresponding to a plurality of pages.

For example, the memory system 100 may be a personal computer, a UMPC (Ultra Mobile PC), workstation, net-book, PDA (Personal Digital Assistants), portable computer, web tablet, wireless phone, mobile phone, e-book, PMP (portable multimedia player), portable game machine, navigation devices, black box, digital camera, 3-dimensional television, digital audio recorder, digital audio player, digital picture recorder, digital picture player, digital video recorder, digital video player, a device capable of transmitting and receiving information at RF circumstance, one of electronic devices constituting a home network, one of electronic devices constituting a computer network, one of electronic devices constituting a telemetric network, RFID device, or one of electronic devices constituting a computing system.

Meanwhile, as an example, the nonvolatile memory device 120 or the memory system 1000 may be packaged in a variety of ways. For example, the nonvolatile memory device 120 or the memory system 100 may be mounted in a package on package (PoP), a ball grid array (BGA) package, a chip scale package (CSP), a plastic leaded chip carrier (PLCC), a plastic dual in-line package (PDIP), a die in waffle pack, a die in wafer form, a chip-on-board (COB), a ceramic dual in-line package (CERDIP), a plastic metric quad flat pack (MQFP), a thin quad flatpack (TQFP), a small outline (SOIC), a shrink small outline package (SSOP), a thin small outline (TSOP), a thin quad flatpack (TQFP), a system in package (SIP), a multi-chip package (MCP), a wafer-level fabricated package (WFP) or a wafer-level processed stack package (WSP).

FIG. 5 illustrates a program state of the memory cell array shown in FIG. 3. Specifically, FIG. 5 illustrates cell distributions of an MLC memory device storing 2-bit data. The cell distributions shown in FIG. 5 may be modified in various shapes.

Referring to FIG. 5, the memory cells may have one of program states “E (Erase)”, “P (Program) 1”, “P2” and “P3.” The memory cells may have voltage distributions corresponding to the program states. The respective program states may be divided by a plurality of threshold voltages VR1, VR2 and VR3.

The program state “E” may correspond to a data value “11” among data values that can be stored in a 2-bit MLC, the program state “P1” may correspond to a data value “10,” the program state “P2” may correspond to a data value “01,” and the program state “P3” may correspond to a data value “00.”

The respective bits may be programmed by page program operations independently performed. The respective program operations may include a plurality of program loops. For example, in a 2-bit MLC, the LSB and the MSB of 2-bit data may be independently programmed by the LSB page program operation and the MSB page program operation, respectively.

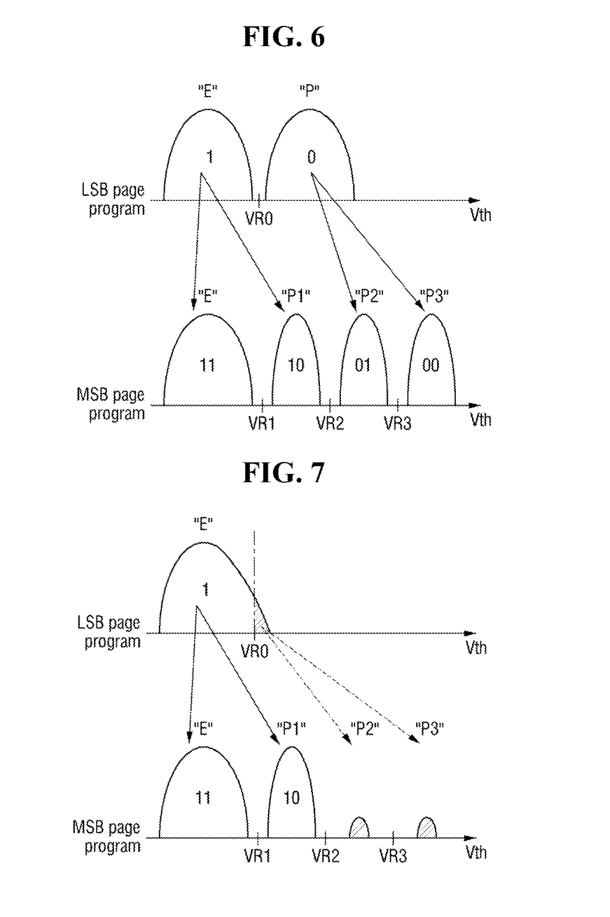

FIG. 6 illustrates a program process of the memory cell array shown in FIG. 3.

Referring to FIG. 6, after the LSB page program operation is performed, the MSB page program operation may be performed based on the cell distribution of the LSB page.

In the LSB page program operation, only the LSB value of the memory cell is programmed to “1” or “0” according to the LSB data value. Here, the MSB is maintained at an erase state. In FIG. 6, when the LSB is programmed to “1,” the program state is indicated by “E” and when the LSB is programmed to “0,” the program state is indicated by “P.”

If the LSB page program operation is completed, the MSB page program operation may be performed. In the MSB page program operation, the MSB value of the memory cell is programmed to “1” or “0” according to the MSB data value. Accordingly, the respective memory cells may have one of four program states. In a read operation using a plurality of threshold voltages, it is possible to sense to which one of data values “11,” “10,” “01” and “00” the memory cell data values are programmed.

FIG. 7 illustrates an LSB page read error in an MSB page program operation.

Referring to FIG. 7, voltage distributions of some of the memory cells programmed in the program state “E” may be varied to be higher than the first threshold voltage VR0.

In the conventional flash memory device, an initial read operation is performed in the MSB page program operation. That is to say, the LSB page data is read from the memory cells connected to the selected word lines of the memory cell array and programmed to have one of the four program states by a combination of the read LSB page data and the MSB page data input from the memory controller (or based on the read LSB page data).

In the conventional flash memory device, the LSB data of some of the memory cells may be read as different data values. Due to the LSB page read error, some memory cells may be programmed to the program state “P2” or “P3,” rather than the target program state “E” or “P1.”

However, in at least one example embodiment of the inventive concepts, the memory module 113 of the memory controller 110 may input LSB page data to the nonvolatile memory device 120 in the LSB page program operation and may temporarily store the LSB page data until the MSB page program operation is completed. In addition, the memory module 113 of the memory controller 110 may input the temporarily stored LSB page data with the MSB page data to the nonvolatile memory device 120 in the MSB page program operation. Once the MSB page program operation is completed, the memory module 113 of the memory controller 110 may erase the temporarily stored LSB page data.

The nonvolatile memory device 120 does not perform an initial read operation in the MSB page program operation but may program the memory cells connected to the selected word lines by a combination of the LSB page data and the MSB page data input from the memory controller 110. Accordingly, a target program state determination error can be improved in the MSB page program operation.

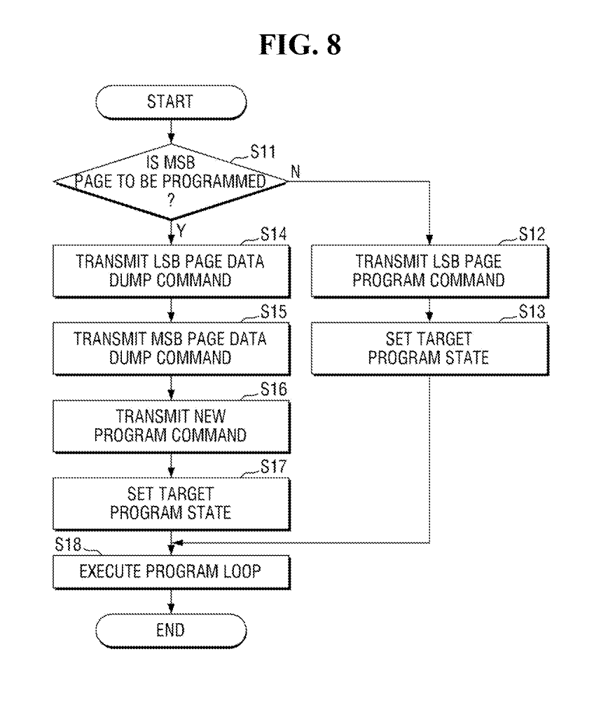

FIG. 8 is a flowchart illustrating a program operation of the memory system shown in FIG. 1.

Referring to FIG. 8, first, the memory controller 110 determines whether the MSB page is to be programmed (S11). A file transfer layer (FTL) of firmware driven by the memory controller 110 may determine whether to program the LSB page or the MSB page in the currently performed program operation.

Next, if the MSB page is not programmed, that is to say, if the LSB page program operation is performed, the memory controller 110 transmits an LSB page program command to the nonvolatile memory device 120 (S 12). Here, the LSB page data and LSB page address may be transmitted simultaneously with or subsequent to the LSB page program command input by the memory controller 110. The LSB page data transmitted to the nonvolatile memory device 120 may be loaded to the C-latch 122d.

Next, the nonvolatile memory device 120 sets the target program state (S13). The LSB page data loaded to the C-latch 122d is dumped to the L-latch 122b, and the S-latch 122a sets the target program state using the LSB page data stored in the L-latch 122b.

Meanwhile, if the MSB page is programmed, the memory controller 110 transmits the LSB page data dump command to the nonvolatile memory device 120 (S14). Here, the LSB page data may be transmitted simultaneously with or subsequent to the LSB page data dump command input by the memory controller 110. The LSB page data transmitted to the nonvolatile memory device 120 may be loaded to the C-latch 122d. Here, the LSB page data is not read from the nonvolatile memory device 120 by the initial read operation but is temporarily stored in the buffer memory of the memory controller 110. In addition, the nonvolatile memory device 120 may dump the LSB page data loaded to the C-latch 122d to the L-latch 122b.

Next, the memory controller 110 transmits an MSB page data dump command to the nonvolatile memory device 120 (S15). Here, the MSB page data may be transmitted simultaneously with or subsequent to the MSB page program command input by the memory controller 110. Here, the MSB page data transmitted to the nonvolatile memory device 120 may be loaded to the C-latch 122d. The nonvolatile memory device 120 may dump the MSB page data loaded to the C-latch 122d to the M-latch 122c.

Next, the memory controller 110 may transmit a new program command to the nonvolatile memory device 120 (S 16). Here, unlike the LSB page program command transmitted with the data and address, only the MSB page address may be transmitted simultaneously with or subsequent to the new program command input by the memory controller 110.

Next, the nonvolatile memory device 120 sets the target program state (S17). The S-latch 122a of the nonvolatile memory device 120 sets the target program state using the LSB page data stored in the L-latch 122b and the MSB page data stored in the M-latch 122c.

Next, the nonvolatile memory device 120 executes a program loop to complete the program operation (S 18). The nonvolatile memory device 120 may write data to the memory cells connected to the word lines corresponding to LSB page address or the MSB page address. The memory device 120 may determine the target program states set to the S-latch 122a and may program the memory cells connected to the word lines to the target program state. Accordingly, the memory cells may have a distribution of voltages corresponding to the target program states.

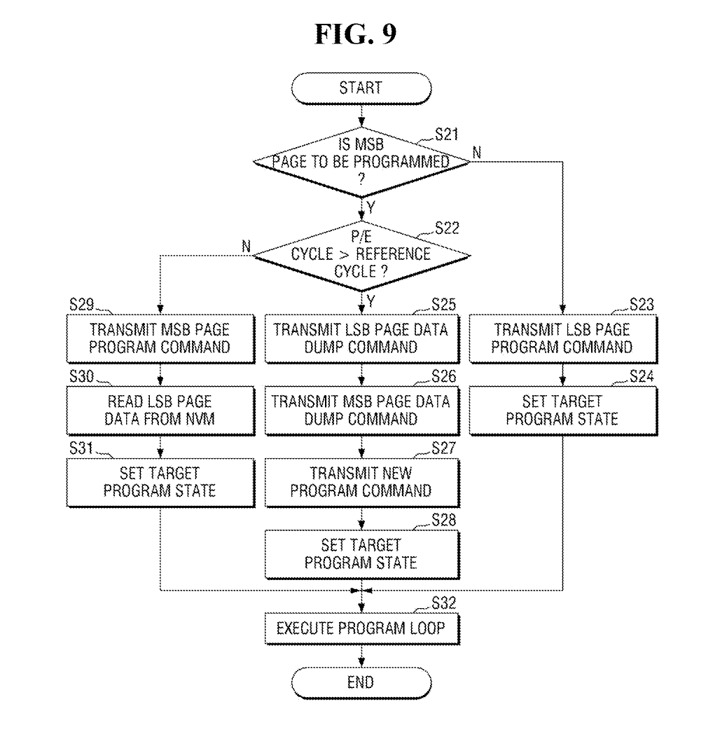

FIG. 9 is a flowchart illustrating an application example of the program operation of the memory system shown in FIG. 1. For the sake of convenient explanation, the following description will focus on differences between the program operations shown in FIGS. 8 and 9.

Referring to FIG. 9, first, the memory controller 110 determines whether the MSB page is to be programmed (S21). Next, if the MSB page is not programmed, the memory controller 110 and the nonvolatile memory device 120 execute steps S23 and S24.

Meanwhile, if the MSB page is programmed, the memory controller 110 determines whether a program/erase cycle of the nonvolatile memory device 120 is greater than a reference cycle (S22).

Next, if the program/erase cycle of the nonvolatile memory device 120 is smaller than the reference cycle, the memory controller 110 may transmit an MSB page program command to the nonvolatile memory device 120 (S29). Here, the MSB page data and MSB page addresses may be transmitted simultaneously with or subsequent to the MSB page program command input by the memory controller 110. The MSB page data transmitted to the nonvolatile memory device 120 may be loaded to the C-latch 122d.

Next, the memory controller 110 reads LSB page data from the nonvolatile memory device 120 (S30). Here, the memory controller 110 reads the LSB page data from the memory cells of the word lines corresponding to the MSB page addresses. The LSB page data read from the nonvolatile memory device 120 may be loaded to the S-latch 122a to then be dumped to the L-latch 122b.

Subsequently, the nonvolatile memory device 120 sets a target program state (S31). The MSB page data loaded to the C-latch 122d is dumped to the M-latch 122c, and the S-latch 122a sets the target program state using the LSB page data stored in the L-latch 122b and the MSB page data stored in the M-latch 122c.

Meanwhile, if the program/erase cycle of the nonvolatile memory device 120 is greater than the reference cycle, the memory controller 110 and the nonvolatile memory device 120 execute steps S25 to S28.

Next, the nonvolatile memory device 120 executes a program loop to complete the program operation (S32). The nonvolatile memory device 120 may write data to the memory cells connected to the word lines corresponding to LSB page address or the MSB page address.

Since steps S23, S24, and S25 to S28 are substantially the same as described above with reference to FIG. 8, detailed descriptions thereof will be omitted.

Meanwhile, if the program/erase cycle of the nonvolatile memory device 120 is smaller than the reference cycle, the memory module 113 of the memory controller 110 may not temporarily store the LSB page data until the MSB page program operation is completed.

A nonvolatile memory device, such as a flash memory device, has a finite program/erase cycle. As the program/erase cycle increases, endurance of the flash memory device is lowered, thereby increasing the number of occurrence of read errors.

In the application example of the program operation of the memory system described with reference to FIG. 9, the MSB page program operation may be executed by referring to the LSB page data temporarily stored in the buffer memory in a first mode according to the program/erase cycle of the nonvolatile memory device 120, or by performing the initial read operation in a second mode. Accordingly, the reliability of data can be improved while securing the performance of the nonvolatile memory device because a large number of read errors are not usually generated at an initial state of the flash memory device.

In another application example, the program operation of the memory system may be modified such that in step S22, the memory controller 110 determines whether the number of error bits due to a read error of the nonvolatile memory device 120 is greater than a reference number.

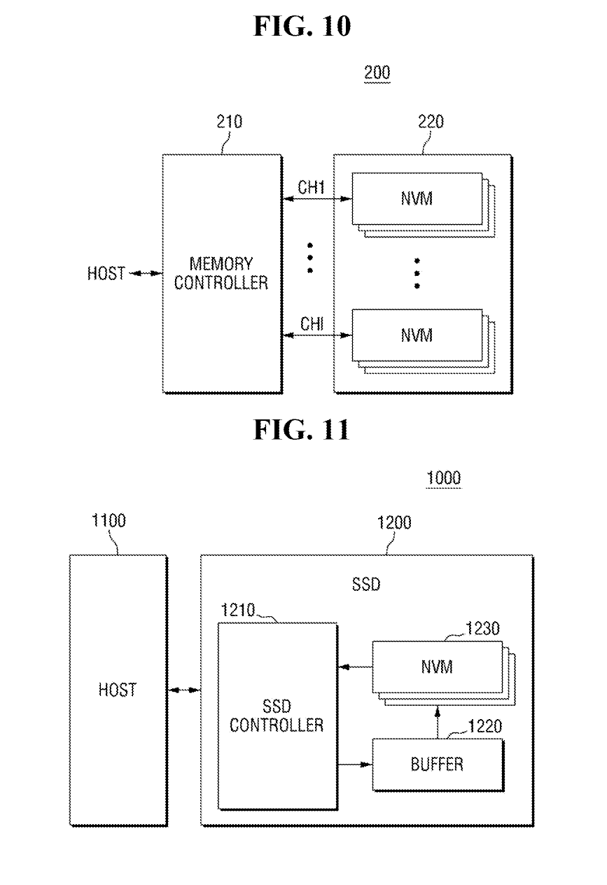

FIG. 10 is a block diagram illustrating an application example of the program operation of the memory system shown in FIG. 1. For the sake of convenient explanation, the following description will focus on differences between the program operations shown in FIGS. 1 and 10.

Referring to FIG. 10, the memory system 200 includes a memory controller 210 and a nonvolatile memory device 220.

The nonvolatile memory device 220 includes a plurality of nonvolatile memory chips. The plurality of nonvolatile memory chips may be divided into a plurality of groups. Each of the groups of the plurality of nonvolatile memory chips may be configured to interface with the memory controller 210 through a common channel. For example, the plurality of nonvolatile memory chips may interface with the memory controller 210 through first to lth channels CH1 to CHl.

The memory controller 210, including the aforementioned buffer memory, temporarily stores LSB page data in an LSB page program operation and the temporarily stored LSB page data may be used in an MSB page program operation.

Each of the nonvolatile memory chips may include the configuration discussed above with reference to the nonvolatile memory device 120 shown in FIG. 1.

In the memory system 200 shown in FIG. 10, a plurality of nonvolatile memory chips are connected to one channel, but aspects of example embodiments of the inventive concepts are not limited thereto. That is to say, one nonvolatile memory chip may be connected to one channel.

FIG. 11 is a block diagram illustrating a user system including a solid state drive.

Referring to FIG. 11, the user system 1000 includes a host 1100 and a solid state drive (SSD) 1200.

The SSD 1200 includes an SSD controller 1210, a buffer memory 1220, and a nonvolatile memory device (NVM) 1230.

The SSD controller 1210 may be configured to interface with the host 1100. The SSD controller 1210 may decode data/commands received from the host 1100 to access the nonvolatile memory device 1230. The SSD controller 1210 may transmit the data received from the host 1100 to the buffer memory 1220. The SSD controller 1210 may read data from the nonvolatile memory device 1230 to then provide the read data to the host 1100.

The buffer memory 1220 may be configured to temporarily store the data received from the SSD controller 1210. The buffer memory 1220 may transmit the temporarily stored data to the nonvolatile memory device 1230. In the SSD 1200 used as a large-capacity auxiliary memory device, the buffer memory 1220 may be provided as a synchronous DRAM to provide sufficient buffering efficiency.

The buffer memory 1220 may temporarily store LSB page data in an LSB page program operation, and the temporarily stored LSB page data may be used in an MSB page program operation.

The nonvolatile memory device 1230 may be provided as a storage medium of the SSD 1200. The nonvolatile memory device 1230 may include a plurality of memory devices. The nonvolatile memory device 1230 may include the configuration discussed above with reference to the nonvolatile memory device 120 shown in FIG. 1.

In FIG. 11. The buffer memory 1220 is positioned outside the SSD controller 1210, but aspects of example embodiments of the inventive concepts are not limited thereto. The buffer memory 1220 may be provided as an internal component of the SSD controller 1210.

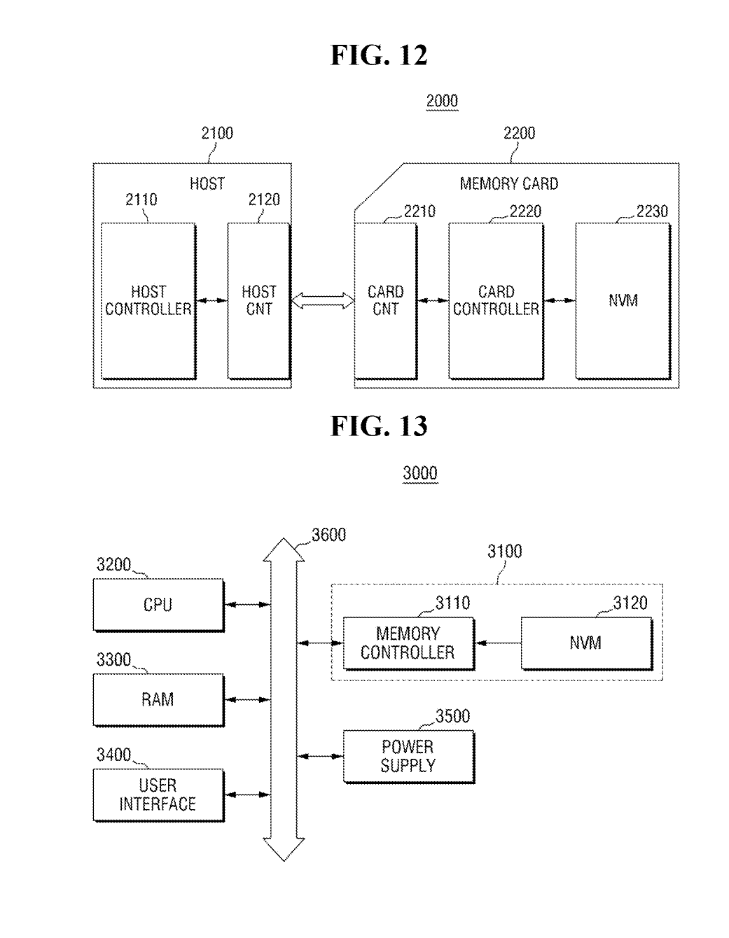

FIG. 12 is a block diagram of a user system including a memory card.

Referring to FIG. 12, the user system 2000 includes a host 2100 and a memory card 2200.

The host 2100 may include a host controller 2110 and a host connection unit (host cnt) 2120. The memory card 2200 may include a card connection unit (card cnt) 2210, a card controller 2220, and a nonvolatile memory device (NVM) 2230.

The host connection unit 2120 and the card connection unit 2210 may be composed of a plurality of pins. The plurality of pins may include, for example, command pins, data pins, clock pins, power supply pins, and so on. The number of pins may vary according to the type of the memory card 2200.

The host controller 2110 may be configured to write data in the memory card 2200 or to read the data stored in the memory card 2200. The host controller 2110 may transmit a command CMD, a clock signal CLK, data DAT, and so on, to the memory card 2200 through the host connection unit 2120.

The card controller 2220 may be configured to write the data to the nonvolatile memory device 2230 or to read the data from the nonvolatile memory device 2230 in response to the command received through the card connection unit 2210. The card controller 2220, including the aforementioned buffer memory, may temporarily store LSB page data in an LSB page program operation, and the temporarily stored LSB page data may be used in an MSB page program operation.

The nonvolatile memory device 2230 may include the configuration discussed above with respect to the nonvolatile memory device 120 shown in FIG. 1.

For example, the memory card 2200 may include a personal computer memory card international association (PCMCIA) card, a compact flash (CF) card, a smart media card, a memory stick, a multimedia card (e.g., MMC, RS-MMC and MMC-micro), a secure digital (SD) card (e.g., SD, mini-SD, micro-SD and SDHC), or a universal flash storage (UFS) card.

FIG. 13 is a block diagram of a computing system including the memory system shown in FIG. 1 or 10.

Referring to FIG. 13, the computing system 3000 includes a memory system 3100, a central processing unit (CPU) 3200, an RAM 3300, a user interface 3400 and a power supply 3500.

The memory system 3100 may be connected to the CPU 3200, the RAM 3300, the user interface 3400, and the power supply 3500 through the system bus 3600. The data provided through the user interface 3400 or processed by the CPU 3200 may be stored in the memory system 3100.

In FIG. 13, the nonvolatile memory device 3120 is connected to the system bus 3600 through the memory controller 3110, but aspects of example embodiments of the inventive concepts are not limited thereto. That is to say, the nonvolatile memory device 3120 may be modified to be directly connected to the system bus 3600.

The memory system 3100 may include the configuration discussed above with respect to the memory system 100 shown in FIG. 1. The memory system 3100 may include the configuration discussed above with respect to the memory system 200 shown in FIG. 10. Additionally, the computing system 3000 may be configured to include any one, or both, of the memory systems 100 and 200 shown in FIGS. 1 and 10.

The memory controller 3100, including the aforementioned buffer memory, temporarily stores LSB page data in an LSB page program operation and the temporarily stored LSB page data may be used in an MSB page program operation.

Example embodiments having thus been described, it will be obvious that the same may be varied in many ways. Such variations are not to be regarded as a departure from the intended spirit and scope of example embodiments, and all such modifications as would be obvious to one skilled in the art are intended to be included within the scope of the following claims.

What is claimed is:

1. A multi level cell memory system comprising:
a nonvolatile memory device including a memory cell array configured to store first bit page data and second bit page data, and a page buffer configured to store data to be programmed in the memory cell array; and
a memory controller configured to input first bit page data and second bit page data into the page buffer,
wherein the memory controller is configured such that the memory controller inputs the first bit page data into the page buffer and temporarily stores the first bit page data in a first bit page program operation, and inputs the second bit page data into the page buffer together with the temporarily stored first bit page data in a second bit page program operation.

2. The multi level cell memory system of claim 1, wherein the memory controller includes a buffer memory and the memory controller is configured to temporarily store the first bit page data to the buffer memory in the first bit page program operation.

3. The multi level cell memory system of claim 1, wherein the page buffer includes a first latch and a second latch, and the memory controller is configured to control the page buffer such that the first bit page data is dumped to the first latch in the first bit page program operation and the second bit page program operation, and the second bit page data is dumped to the second latch in the second bit page program operation.

4. The multi level cell memory system of claim 1, wherein the memory controller is configured to erase the temporarily stored first bit page data after the second bit page program operation is completed.

5. The multi level cell memory system of claim 1, wherein the memory controller is configured such that,
when a program/erase cycle of the nonvolatile memory device is greater than a reference cycle, the memory controller temporarily stores the first bit page data in the first bit page program operation and inputs the second bit page data together with the temporarily stored first bit page data to the page buffer in the second bit page program operation, and
when a program/erase cycle of the nonvolatile memory device is not greater than a reference cycle, the memory controller does not temporarily store the first bit page data in the first bit page program operation, the memory controller inputs the second bit page data to the page buffer in the second bit page program operation, and the memory controller does not input the first bit page data to the page buffer in the second bit page program operation.

6. The multi level cell memory system of claim 1, wherein the memory controller is configured such that,
when the number of error bits due to a read error of the nonvolatile memory device is greater than a reference number, the memory controller temporarily stores the first bit page data in the first bit page program operation and inputs the second bit page data together with the temporarily stored first bit page data to the page buffer in the second bit page program operation, and
when the number of error bits due to a read error of the nonvolatile memory device is not greater than a reference number, the memory controller does not temporarily store the first bit page data in the first bit page program operation, the memory controller inputs the second bit page data to the page buffer in the second bit page program operation, and the memory controller does not input the first bit page data to the page buffer in the second bit page program operation.

7. The multi level cell memory system of claim 1, wherein the memory controller is configured such that the first bit page data is least significant bit (LSB) page data, and the second bit page data is most significant bit (MSB) page data.

8. The multi level cell memory system of claim 1, wherein the nonvolatile memory device is a NAND type flash memory device.

9. A multi level cell memory system comprising:
a nonvolatile memory device configured to store data; and
a memory controller configured to input data to be programmed to the nonvolatile memory device,
wherein the nonvolatile memory device includes,
a memory cell array,
a first latch configured to temporarily store first bit page data to be programmed in the memory cell array, and
a second latch configured to temporarily store second bit page data to be programmed in the memory cell array,
the memory controller being configured such that the memory controller,
dumps the first bit page data to the first latch in the first bit page program operation and the second bit page program operation, and
dumps the second bit page data to the second latch in the second bit page program operation.

10. The multi level cell memory system of claim 9, wherein the memory controller is configured such that the memory controller,
dumps the first bit page data to the first latch and temporarily stores the first bit page data in the first bit page program operation, and
dumps the temporarily stored first bit page data to the first latch and dumps the second bit page data to the second latch in the second bit page program operation.

11. The multi level cell memory system of claim 10, wherein the memory controller includes a buffer memory configured to temporarily store the first bit page data in the first bit page program operation.

12. The multi level cell memory system of claim 10, wherein the memory controller is configured to erase the temporarily stored first bit page data after the second bit page program operation is completed.

13. The multi level cell memory system of claim 9, wherein the nonvolatile memory device further comprises:
a third latch, the memory controller being configured to cause the third latch to set a target program state of the memory cell array based on the data temporarily stored in the first latch and the data temporarily stored in the second latch in the second program operation.

14. The multi level cell memory system of claim 9, wherein the memory controller is configured such that,
when a program/erase cycle of the nonvolatile memory device is greater than a reference cycle, the memory controller dumps the first bit page data to the first latch in the first bit page program operation and the second bit page program operation, and
when a program/erase cycle of the nonvolatile memory device is not greater than a reference cycle, the memory controller dumps the first bit page data to the first latch in the first bit page program operation, and the memory controller does not input the first bit page data to the page buffer in the second bit page program operation.

15. The multi level cell memory system of claim 9, wherein the memory controller is configured such that,
when the number of error bits due to a read error of the nonvolatile memory device is greater than a reference number, the memory controller dumps the first bit page data to the first latch in the first bit page program operation and the second bit page program operation, and
when the number of error bits due to a read error of the nonvolatile memory device is not greater than a reference number, the memory controller dumps the first bit page data to the first latch in the first bit page program operation, and the memory controller does not input the first bit page data to the page buffer in the second bit page program operation.

16. A memory system comprising:
a nonvolatile memory device, the nonvolatile memory device including,
an array of multi-level memory cells, and
a page buffer; and
a memory controller including a buffer memory, the memory controller being configured to
program first bits into selected cells, from among the array of multi-level memory cells, by storing first page data corresponding to the first bits in the page buffer, and programming the first bits into the selected memory cells based on the first page data stored in the page buffer, and
temporarily store the first page data to the buffer memory, and
program second bits into the selected cells by storing second page data corresponding to the second bits in the page buffer, and programming the second bits into the selected memory cells based on both the first page data stored in the buffer memory and the second page data stored in the page buffer.

17. The multi level cell memory system of claim 16, wherein the memory controller is configured such that the first bits are least significant bits (LSBs), and the second bits are most significant bits (MSBs).

18. The multi level cell memory system of claim 16, wherein the memory controller is configured to erase the temporarily stored first bit page data after the second bit page program is completed.

19. The multi level cell memory system of claim 16, wherein the buffer memory is a SRAM (Static Random Access Memory).

20. The multi level cell memory system of claim 19, wherein the nonvolatile memory device is a NAND type flash memory device.
